(19) United States
(12) Patent Application Publication
(10) Pub. No.: US 2003/0017326 A1
(43) Pub. Date: Jan. 23, 2003

(54) Color stable pigmented polymeric films having dyes for color adjustment

(75) Inventors: Daniel J. McGurran, Woodbury, MN (US); James A. Olson, Maplewood, MN (US); Mark N. Schaeffer, Hudson, WI (US)

Correspondence Address: Attention: Stephen C. Jensen, Office of Intellectual Property Counsel, 3M Innovative Properties Company, P.O. Box 33427, St. Paul, MN, 55133-3427, US

(73) Assignee: 3M Innovative Properties Company

(21) Appl. No.: 09/872,532

(22) Filed: Jun. 1, 2001

(51) Int. Cl. B32B 5/16; B32B 27/36

(52) U.S. Cl. 428/323; 428/328; 428/329; 428/331; 428/480

(57) ABSTRACT

Color-stable, pigmented optical bodies comprising a single or multiple layer core having at least one layer of a thermoplastic polymer material. The thermoplastic polymer material has dispersed within it a particulate pigment. The optical bodies generally possess high clarity and low haze and exhibit a transmission of light within a wavelength band of interest within the visible spectrum of from about 10 to about 90 percent. The optical bodies also comprise one or more dyes in an amount sufficient to adjust transmitted color, by no more than about 15 units of the color coordinate a* and no more than about 15 units of the color coordinate b*, to a target color such as neutral gray.

### FIELD OF THE INVENTION

The present invention relates to color-stable polymeric films and products made therefrom. More particularly, the present invention relates to color-stable pigmented polymeric films made of a polyester and including one or more dyes for color adjustment.

### BACKGROUND

Tinted polymeric films, and particularly tinted polymeric films made of a polyester, find utility in a broad range of applications. These films, for example, can be applied to a base transparent substrate (e.g., a window or auto glass pane) to provide a neutral color tint to the window or auto glass. They can also be used to tint the surface of a display device, mirror, or other piece of optical equipment.

One method for tinting a polymeric base film employs dyeing the base film with one or more color dyes. Typically in such methods, the neutral color, or “tint,” is obtained by imbibing (or blending) the base film material with a combination of yellow, red, and blue dyes. While these dyed films generally retain a high clarity and a low haze, prolonged exposure to ultraviolet radiation (which occurs naturally during outdoor use or by exposure to fluorescent light or other UV-emitting light source) can cause significant degradation of the dye molecules and lead to tinting color alteration, tinting power deterioration, bleachings, and reduced light transmission. Some of these problems are a result of the fact that different dyes degrade at different rates, and the tinted color of the film relies solely or at least predominantly on the properties of the constituent dyes.

Another method sometimes employed for tinting a polymeric film is to apply a pigmented coating to the surface of a base polymeric film. Generally, such coatings are applied as thin layers and employ a relatively high pigment concentration to achieve a desired tint level. These highly-concentrated pigment coatings can suffer myriad processing and performance drawbacks. For example, the high pigment concentrations necessary to achieve requisite tinting strengths are difficult to uniformly disperse within the thin coating, and these high surface pigment concentrations generally suffer faster environmental deterioration. Moreover, such pigmented coatings typically suffer greater haze and reduced clarity.

Color-stable pigmented optical bodies such as films are described in co-pending U.S. application Ser. No. 09/633,911, filed Aug. 8, 2000 and incorporated herein by reference. In the '911 application, the described optical bodies have at least one layer of a thermoplastic polymer material, and generally possess high clarity and low haze and exhibit a transmission of light from about 10 to about 90%. It has been found, however, that where a particular transmitted color is desired for the optical body, it may be difficult and/or expensive to identify one or more pigments that will achieve the desired percent transmission level as well as the desired transmitted color while maintaining high clarity and low haze. A particular pigment may satisfy all of the desired properties mentioned in the preceding sentence, except it might impart an actual transmitted color that differs from the target color by a relatively small but visually noticeable amount. There exists, therefore, a need for a pigmented film that is environmentally stable (i.e., color-stable or colorfast), that is easily manufactured, and that exhibits low haze, high clarity, and a particular desired transmitted color that may differ from a color associated with the pigment(s) used in the film.

### BRIEF SUMMARY

The present application discloses color-stable, pigmented optical bodies, such optical bodies comprising at least one layer of a thermoplastic polymer material having dispersed therein a particulate pigment, wherein the optical body exhibits a transmission of light within a wavelength band of interest within the visible spectrum of from about 5 to about 90 percent and exhibits less than or equal to about five percent internal haze. The dispersed particulate pigment imparts a substantial transmitted color to the optical body that differs from a desired transmitted color. Accordingly, the optical body further comprises at least one dye in an amount sufficient to adjust the transmitted color of the optical body to the desired transmitted color.

Generally, the dye concentration is kept relatively low so that it has a minor effect on the percent transmission of the optical body compared to the effect of the particulate pigment. In one aspect, the dye(s) produce a shift in the color coordinates a*, b* of the optical body of no more than about 15 units each. Accordingly, any dye degradation or instability has much less of an impact on transmitted color (and on percent transmission) than a film in which the transmitted color and percent transmission are due solely or substantially to one or a combination of dyes. The use of dyes for color adjustment is also advantageous because of the ready availability of a variety of dyes in a multitude of colors, many of which can be processed to have high clarity and low haze.

In some embodiments, the desired transmitted color is a substantially neutral gray. In such embodiments carbon black particulate having a mean diameter of between 10 nm and 500 nm, or simply ≦500 nm, is one suitable pigment. Such a pigment, when dispersed in the polymer material at levels sufficient to yield a percent transmission of about 5 to 80%, can impart a noticeable yellow or bronze color to the optical body. This is particularly true for very small diameter particulate sizes. The yellow color is however normally within about 10 to 15 units of b* and within about 5 units or less of a* of the desired neutral gray. In such case a blue dye (possibly in combination with other dyes such as a red dye) can be used to adjust the transmitted color of the optical body to the target color.

In some embodiments, the dye is disposed in the polymer material in which the pigment is dispersed. In some embodiments, dyes can alternatively or in addition be included in a layer separate from a layer in which the particulate pigment is dispersed.

In some embodiments, the dye can react into the chemical chain of the polymer, thus becoming copolymerized in the polymer material. Non-copolymerizable dyes can also be used.

Further disclosed is a method of making a color-stable, pigmented optical body, the method comprising:

(a) creating a substantially uniform dispersion of a particulate pigment having a mean diameter of about 500 nm or less;

(b) adding the dispersion to a reaction mass of a condensation polymer forming process, wherein the dispersion is present in an amount sufficient to impart a transparency to the optical body between about 10 and 90 percent;

(c) reacting the condensation polymer forming reaction mass to form a condensation polymer having dispersed therein the particulate pigment; and

(d) forming an optical body comprising at least one layer of the condensation polymer. The method further includes incorporating the color adjustment dye(s) into the optical body by: (1) adding the dye(s) to the reaction mass of step (b); or (2) separately compounding the dye(s) into a melt of the same or a compatible polymer and combining with the pigment-containing condensation polymer in step (d); or (3) adding the dye to a second reaction mass of the same or a compatible condensation polymer and reacting such polymer to form a condensation polymer having the dye moieties copolymerized or otherwise mixed therein, and combining the pigment-containing reaction mass and the dye-containing reaction mass in step (d); or (4) incorporating the dye into step (d) by metering the dye directly into the apparatus (such as a twin screw extruder) used for forming the optical body.

Still further, the present disclosure provides articles, including pigmented window and auto glass films, that incorporate the above color-stable optical bodies.

### BRIEF DESCRIPTION OF THE DRAWINGS

FIG. 1 is a photomicrograph of a pigmented optical body having a substantially uniform particulate dispersion suitable for use with the disclosed embodiments;

FIG. 2 depicts the effect of color adjustment on a graph of the conventional color coordinates a*, b*;

FIG. 3 depicts transmission spectra over the visible wavelength region for a conventional dyed polyester (PET) glazing film, for a polyester (PET) film pigmented with a particulate pigment (carbon black), and for a polyester (PET) film pigmented with a particulate pigment (carbon black) and also dyed for adjustment of transmitted color; and

FIGS. 4a-b depict the stability of transmitted color (a*, b* respectively) of a pigmented film having dyes for color adjustment compared to conventional dyed polyester glazing film.

### DETAILED DESCRIPTION OF THE ILLUSTRATIVE EMBODIMENTS

The optical bodies described herein generally comprise a base polymeric core into which there is uniformly dispersed a particulate pigment having a selected mean diameter. The optical bodies are generally constructed such that the transmission of the body within a desired portion of the visible spectrum (i.e., between about 400 nm and about 700 nm) can be controlled from 5 to 90 percent while simultaneously exhibiting a low degree of haze. In some embodiments, at least one additional transparent layer is disposed on at least one outer surface of the core body and is substantially free of the particulate pigment material. This additional layer is sometimes referred to as a “skin” layer. The base polymeric core comprises at least one oriented or non-oriented thermoplastic pigmented material, generally, but not necessarily, in the form of a film. In its entirety the core can be comprised of one, several, or many individual layers. In some embodiments, the core body is a multi-layer optical film.

The core of the optical body can incorporate any thermoplastic polymer material, including any polyester-containing polymer. Useful polyester polymers include polymers having terephthalate or naphthalate comonomer units, for example, polyethylene naphthalate (PEN), polyethylene terephthalate (PET) and copolymers and blends thereof. Examples of other suitable polyester copolymers are provided in, for example, published patent application WO 99/36262 (Hebrink et al.) and in WO 99/36248 (Neavin et al.), both of which are incorporated herein by reference. Other suitable polyester materials include polycarbonates, polyarylates, and other naphthalate and terephthalate-containing polymers, such as, for example, polybutylene naphthalate (PBN), polypropylene naphthalate (PPN), polybutylene terephthalate (PBT) and polypropylene terephthalate (PPT), and blends and copolymers of any of the above with each other or with non-polyester polymers.

The optical body core can also include or be comprised of a multi-layer optical film. Generally speaking, multi-layer optical films are used to create optical interference filters that reflect light via designed constructive interferences between a multiplicity of layers with alternating low and high indices of refraction. Such films can be composed of either isotropic or birefringent layers, or both. Birefringent optical films are constructed in multi-layer “stacks” for which the Brewster angle (the angle at which reflectance of p-polarized light goes to zero) is controlled to a desired value by control of the relative values of the various indices of refraction in the layers. This property allows for the construction of multilayer mirrors and polarizers whose reflectivity for p-polarized light decreases slowly with angle of incidence, is independent of angle of incidence, or that increases with angle of incidence away from the normal. As a result, multilayer films having high reflectivity (for both s- and p-polarized light for any incident direction in the case of mirrors, and for the selected polarization in the case of polarizers) over a wide bandwidth can be achieved.

Useful multilayer constructions are disclosed, for example, in the following published patent applications, all of whose descriptions are incorporated herein by reference: WO 95/17303 (Ouderkirk et al.), WO 96/19347 (Jonza et al.), and WO 97/01440 (Gilbert et al.). Among the most useful films are multi-layer constructions made of alternating thin layers of PEN and a co-polymer of PEN, for example a 70-naphthalate/30-terephthalate co-polyester (co-PEN), or other polymers having a lower refractive index than PEN.

Often, the ability to achieve properties desired in a single or multi-layer polymeric body is influenced by the processing conditions used to prepare it. The polymeric optical body, for example, can be formed by a casting process wherein a molten polymer composition is extruded through a die and cast as a film upon a cooled casting wheel. The desired casting thickness of the cast film will depend in part on the desired use for the optical body, and may be achieved by control of the process conditions under which the body is formed. Typical casting thicknesses range from about 0.3 mm to as much as 3.0 mm, though, depending on the particular end use, thinner or thicker castings can be made.

A cast polymeric body can optionally be oriented, again depending on the particular set of properties desired. Typically, an oriented body is oriented after a quenching process in either or both the lengthwise (sometimes referred to as machine) direction and the transverse (or cross-machine) direction. Although the degree of orientation in either direction can vary greatly (and are not necessarily the same), typically stretching dimensions vary between 2.5 and 5.0 times the body's cast dimensions. A cast polymeric body can also be heated before or during orientation, e.g., by infrared lamps or forced convection, to raise its temperature to slightly above its glass transition temperature.

When multi-layer optical films are employed, for example, it may be desirable to achieve given relationships among the various indices of refraction (and thus the optical properties) of the multilayer device. In the case of organic polymer films, these properties can be obtained and/or controlled by stretching or orientation. Generally, this is accomplished by preparing the polymer films by co-extruding the individual polymers to form a multilayer film and then orienting the film by stretching at a selected temperature, optionally followed by heat-setting at a selected temperature. Alternatively, the extrusion and orientation steps can be performed simultaneously. In the case of multilayer optical bodies in the form of a polarizer, the multilayer film typically is stretched substantially in one direction (uniaxial orientation). In the case of multilayer optical bodies in the form of a mirror, the film is stretched substantially in two directions (biaxial orientation).

When stretched, the core polymeric body may also be allowed to dimensionally relax in the cross-stretch direction from the natural reduction in cross-stretch (equal to the square root of the stretch ratio) or may also be constrained (i.e., no substantial change in cross-stretch dimensions). The core film may be stretched in the machine direction, as with a length orienter, and in the width direction using a tenter, or at diagonal angles.

It will be understood with respect to such stretching and orientation processes, that the pre-stretch temperature, stretch temperature, stretch rate, stretch ratio, heat set temperature, heat set time, heat set relaxation, and cross-stretch relaxation are selected to yield a film having desired properties, including a desired refractive index relationship. These variables are inter-dependent; thus, for example, a relatively low stretch rate could be used or coupled with, e.g., a relatively low stretch temperature. It will be apparent to one of ordinary skill how to select the appropriate combination of these variables to achieve a desired multilayer device. In general, in the case of multilayer films that are in the form of polarizers, preferred stretch ratios are 1:2-10 (more preferably 1:3-7) along one axis and 1:0.5-1 (more preferably 1:1-7, most preferably 1:3-6) along a second axis. In the case of mirror films, it is generally preferred that the stretch ratio along both axes (which can be the same or different from one another) be in the range of 1:2-10 (more preferably 1:2-8, and most preferably 1:3-7).

Whether the optical body comprises multiple layers or consists essentially of a single layer, the polymeric core comprises at least one layer of a thermoplastic polymer material wherein dispersed within the thermoplastic material is a particulate pigment. The uniformly-dispersed pigment will be composed of particles that have a mean diameter of about 500 nm or less. The relatively small size of these particles helps to reduce the surface roughness of the overall pigmented film and helps to reduce the amount of internal light scattering, which can deleteriously raise the surface and bulk haze of the film, respectively. Generally, the most readily available and widely used particulate pigments will be conventional carbon blacks, many different grades of which are available commercially. Other usefull pigments include the following: inorganic compounds such as oxides, salts and other compounds of iron, titanium, antimony, zirconium, zinc, barium, calcium, cadmium, lead, chromium, molybdenum, manganese, silicon, aluminum, sodium, cobalt, copper, and other metals, such compounds being exemplified by iron oxides, ammonium ferrocyanides (iron blues), titanium dioxides, antimony oxides, zirconium oxides, zirconium silicates, zinc oxides, zinc sulfides, barium sulfates, calcium carbonates, calcium sulfates, cadmium sulfides, cadmium selenides, lead sulfates, chromium oxides, chromates, molybdates, manganates, silica, silicates, aluminosilicates, sodium alumino sulphosilicates (ultramarines) such as Ultramarine Blue, Ultramarine Violet, and Ultramarine Pink, and other metal oxides, as well as other simple and complex inorganic compounds; inorganic complexes, such as e.g. Pigment Blue 28, Cobalt Blue, Cobalt Aluminate, King's Blue, Thenard's Blue, Cadmium Red, Molybdate Orange, Lead Molybdate, Chrome Yellow, Lead Chromates, Chrome Green, Pigment Yellow 53, Titanium Yellow, Nickel Titanate, Nickel Antimony Titanate, Nickel Titanate Yellow, Pigment Violet 16, Manganese Violet, Permanent Violet, Nuremberg Violet, Mineral Violet, and Fast Violet; and organic pigments such as phthalocyanines, copper phthalocyanines, quinacridones, anthraquinones, perylenes, perinones, dioxazines, diketo-pyrrolo-pyrrols (DPPs), indanthrones, benzidines, isoindolines and isoindolinones, benzimidazolones, and azo, disazo, or polyazo pigments (such as Naphthol Red, diarylides, dianisidine, and pyrazolone) including metallized azo pigments (such as Lake Red C, Permanent Red 2B, Nickel Azo Yellow, Lithol Red, and Pigment Scarlet). These various pigments can be used alone or in combination to achieve different tinting tones, absorption profiles, and/or physical properties. The particulate pigment (which may comprise a blend of different pigments) should be incorporated within the thermoplastic polymer in proportion to the level of pigmentation, or “tinting,” desired for the overall construction. Generally, the particulate pigment will be added to the thermoplastic polymer in an amount between about 0.02 and 0.5 percent by weight, though more or less pigment can be employed depending on the application and depending on the particular pigment chosen.

In certain embodiments, two or more particulate pigments can be used in combination with one another to achieve coloration close to the target color.

Generally, to be used in the disclosed embodiments, commercial-sized agglomerates or beads of pigment are reduced to a median diameter of between about 10 and 500 nm. More preferably, the pigmented beads are reduced to a mean diameter of no more than 300 nm, or no more than 100 nm. This may be accomplished, for example, by milling the agglomerates in a minimum amount of a solvent, for example ethylene glycol, preferably also in the presence of a dispersing agent such as polyvinylpyrrolidone (PVP). Generally, the dispersant, e.g., the PVP, is added in an amount from about 1 to 100 parts by weight per 100 parts of carbon black, with greater amounts of dispersant being used as the particle size of the pigment decreases (and as the surface area of the pigment increases for a given weight percent loading).

The particulate pigment dispersion can be incorporated into the thermoplastic polymer material for example by milling the pigment into the polymer using conventional mixing and/or milling equipment. A uniform dispersion of the particulate pigment throughout the thermoplastic material is, however, more readily achieved by dispersing the pigment into the polymer during polymerization. This allows for the dispersing of the pigment throughout a relatively low viscosity monomer mixture, avoiding the more difficult milling processes. To accomplish this, the particulate pigment can be dispersed into the polymer reactant medium in a suitable solvent, for example, ethylene glycol, with the aid of PVP or other dispersant. This dispersion may also be added to the reaction mass of a condensation polymer-forming process. Useful uniform dispersions of carbon black particles, for example, can be obtained by adding the milled carbon black, ethylene glycol, and dispersant to the polyester reaction mass immediately following the ester interchange step.

A generally preferred method for incorporating the particulate pigment into the pre-polymerized reaction mass is to first create a slurry of the particulate pigment in ethylene glycol. A useful slurry can be created with 10 percent pigment by weight in the ethylene glycol. As noted above, the slurry can also incorporate one or more wetting or dispersing agents, such as PVP. The slurry can be pre-mixed and, after pre-mixing, be passed several times through a media mill. The milled mixture can also be passed through a fine filter (e.g., on the order of 1 micron) to provide additional particle size control and to remove impurities or other unwanted elements. The final mixture can be charged directly to a reaction vessel along with the pre-polymerized condensation polymer forming reaction mass. The resulting polymer typically will be loaded with about 1 percent by weight of the pigment. The high shear mixing both within the mill during mixing and during the polymerization reaction within the reaction vessel can help contribute to the uniformity of the pigment dispersion within the polymer and can help reduce undesired agglomeration of the particles in the polymer resin.

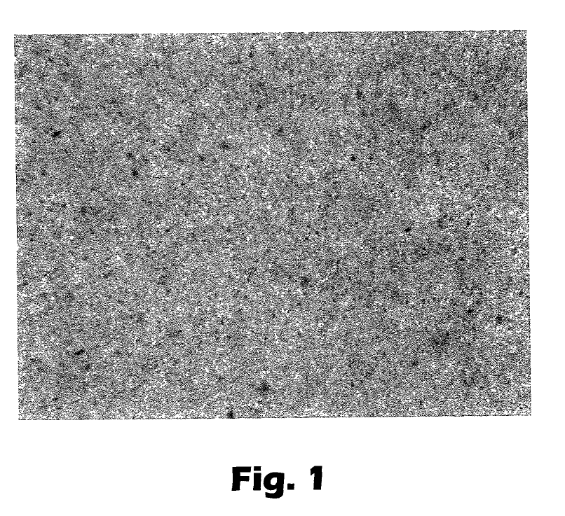

FIG. 1 is a photomicrograph (magnification of 320×) of carbon black particulate dispersed in a PET film at a loading of 0.08 weight %. Reference is made to Example 7 of copending U.S. application Ser. No. 09/633,911, discussed above. The particulate dispersion was measured to be free of agglomerations larger than 1 micron, with a volume fraction average particle/agglomerate size of less than 500 nm.

At least one additional layer can also optionally be placed in contact with at least one outer surface of the optical body core containing the pigmented thermoplastic polymer material. This surface layer can act to reduce the surface roughness of the overall construction and maintain the clarity and low haze of the optical body. These surface, or “skin,” layers typically are free of the particulate pigment. The skin layer or layers can be coextruded onto one or both outer surfaces of the core optical body. Alternatively, the skin layer or layers can be coated or laminated onto the core body using a suitable pressure sensitive or non-pressure sensitive adhesive. Suitable coatings include, but are not limited to, hardcoats, adhesives, antistatics, adhesion promoting primers, UV stabilizing coatings, etc. One or more additional layers (films, laminates, and/or coatings) can also be incorporated along with the skin layers. The skin layers are preferably made of a transparent polymer, for example, a polyester (the same or different as that used in the construction of the core film), polyolefin, polycarbonate, or other thermoplastic polymer.

Preferred pigmented optical bodies will have a relatively smooth surface and a low haze. A useful indication of the surface character of an optical body is the roughness average, or surface roughness, Rₐ. Such Rₐ values can be measured, for example, according to ASTM test method F1811-97. Optical bodies as described herein can and preferably are made to have a surface roughness, Rₐ, of less than or equal to about 60 nm, more preferably less than or equal to about 30 nm.

Similarly, a useful measure of the “haze” of an optical body can be determined from the percentage of light which, in passing through the body, deviates from the incident beam through forward scatter by more than a specified average degree. ASTM D1003 provides one method for making such a measurement. When the haze of an optical body is determined by light impinging upon the body when exposed to air, the measured haze includes the haze caused by both surface scattering and internal scattering effects. This is considered the “total” haze for the optical body. The optical effects generated by the body itself internally, or “internal” haze, can be determined by measuring the haze of the optical body when it is immersed in a fluid of substantially similar refractive index. Generally, the optical bodies described herein will exhibit an internal haze of less than about five percent, preferably less than about three percent, and more preferably less than about two percent. Preferred optical bodies will also exhibit a total haze of less than about ten percent, more preferably less than about five percent.

The disclosed optical bodies also include one or more dyes for color adjustment with respect to a color imparted by the dispersed particulate pigment. Before continuing with a description of the color adjustment, a brief discussion of color measurement will be given for background.

The color of an optical body can be defined on the L*, a*, and b* color scales. The L*, a*, and b* values are based upon the CIE (International Commission on Illumination) method, which determines the color scales using the transmission or reflection of the test material as a function of the wavelength of incident light, the spectral power of a chosen standard illuminant, and the color-matching functions of a CIE standard observer. The CIE procedures for determining L*, a*, and b* values are described in detail in ASTM E308 and ASTM E1164. ASTM E308 discusses the standard practice for computing the colors of objects using the CIE system, and ASTM E1164 discusses the standard practice for obtaining spectrophotometric data for object-color evaluation. The L*, a*, and b* values cited herein are those determined using transmission within the visible spectrum, the CIE standard Illuminant C (representing daylight), and the color-matching functions of a 2 degree CIE standard observer.

The L*, a*, and b* color scales for a given object serve as coordinates to describe a certain color region in three-dimensional color space. The a* and b* values relate to the hue and saturation of the color. For example, a positive a* value is indicative of red, while a negative a* value is indicative of green. A positive b* value is indicative of yellow, while a negative b* value is indicative of blue. While the sign (positive or negative) of the a*, b* values indicates the hue of the optical body, the absolute value indicates the saturation of that hue—an increasing absolute value corresponds to a higher saturation.

A neutral gray color corresponds to both a* and b* having a value at or near zero. For purposes of the present application, neutral gray will be considered to be:

|a*|≦5 and |b*|≦5; or

|a*|≦3 and |b*|≦3(more preferable); or

|a*|≦1 and |b*|≦1(more preferable still); or

|a*+1.5|≦5 and |b*+1.5|≦5; or

|a*+1.5|≦3 and |b*+1.5|≦3(more preferable); or

|a*+1.5|≦1 and |b*+1.5|≦1(more preferable still).

The latter three conditions are biased toward a neutral gray having a very slight blue/green tint (a*=b*=−1.5), which is desirable in certain window glazing applications.

The L* value relates to the intensity or brightness of the optical body. Larger L* values correspond to whiter optical bodies, and smaller L* values correspond to darker optical bodies. An L* value of zero corresponds to black.

Desirably, the optical bodies disclosed herein include one or more dyes at levels that are small compared to conventional dyed PET films but sufficient to adjust the color of the optical body by up to about 15 units on the a* and/or b* scales. High loadings of carbon black particulate, for example, can produce optical bodies that are close to neutral gray but having a significant yellow (positive b*) color component. Color adjustment to neutral gray can be achieved by addition of a small amount of blue dye possibly in combination with small amounts of other dyes such as a red dye for fine color adjustment. Other particulate pigments or combinations thereof can impart a substantially different color to an optical body, such different color being close to a target color other than neutral gray. Again, relatively small amounts of dye can be incorporated into the optical body to adjust the color by up to about 15 units in a* and/or b*.

As discussed above, the dye concentration is kept relatively low so that it has a minor effect on the percent transmission of the optical body compared to the effect of the particulate pigment. Accordingly, any dye degradation or instability has much less of an impact on transmitted color (and on percent transmission) than a film in which the transmitted color and percent transmission are due solely or substantially to one or a combination of dyes. Moreover, dyes having high clarity and low haze are readily available in a multitude of colors.

The dye(s) can be incorporated into the same layer in which is dispersed the particulate pigment, or in a different layer of the optical body. Further, the dye(s) can be of the type that copolymerize into the polymer matrix in which it is disposed. Such copolymerizable dyes are known in the art, having been developed by companies such as Eastman Chemical Company.

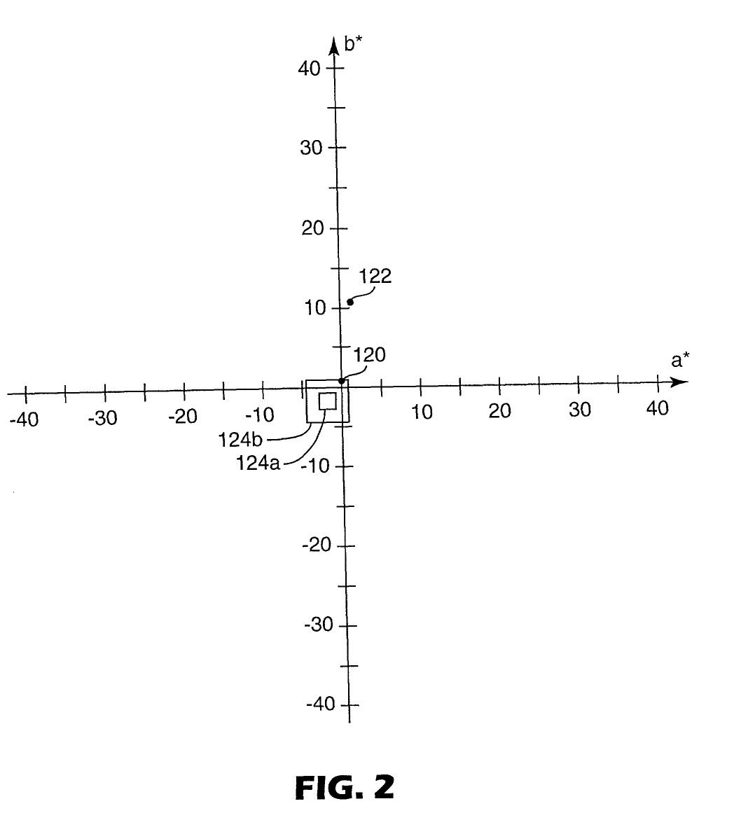

FIG. 2 demonstrates color adjustment of pigmented optical bodies with dyes in a graphical manner. The graph plots color coordinate a* versus color coordinate b*. Point 120 represents a simple single-layer PET film. The film has a high percent transmission of about 90%, down from 100% primarily due to Fresnel reflections from its two major surfaces. The film has a very slight yellowish tint (small positive b* value) due to inherent characteristics of the PET. It is known to correct this slight inherent tint with cobalt acetate or with toners (very dilute dyes). Point 122 represents the same PET film but with a specific loading of carbon black particulate (0.36 wt % loading, mean particulate diameter under 300 nm, film thickness of 23 μm) sufficient to yield a percent transmission over the visible spectrum of 35%. The pigmented film, as seen from the position of point 122, has a small but noticeable yellowish tint associated with the nominally “black” pigment. Boxes 124a, 124b represent a target neutral gray color with a slight bias towards blue/green, with box 124a being a preferred target (|a*+1.5|≦1 and |b*+1.5|≦1) and 125b being a less preferred but still acceptable target (|a*+1.5|≦3 and |b*+1.5|≦3). The transmitted color of the optical body is adjusted from point 122 to a position within box 124b and preferably also box 124a by addition of a predominantly blue dye to shift the b* value downward by about 10 to 15 units. In practice, it has been found that certain blue dyes have a substantial green component, yielding an a* value to the left of boxes 124a, 124b. In such case a small amount of red dye may be needed to shift the a* value to the right so that the finished optical body falls within the targeted color box.

The blue dye—and red dye, if present—collectively contribute a minor amount to the reduction of percent transmission of the optical body compared to the contribution of the pigment. For example, the dye-adjusted pigmented film described in the preceding paragraph may have an overall percent transmission of 35% over the visible spectrum. That is, 65% of the light incident on the film is absorbed, reflected, or otherwise blocked from passing through the film. The 65% figure in turn can be broken up into approximately 10% due to Fresnel surface reflection, approximately 45% due to the carbon black pigment particulate, and approximately 10% due to the dyes.

Target colors other than neutral gray may be desired for certain applications. For example, conventional x-ray film has a characteristic blue color that may be difficult to precisely match with readily available pigments. Relatively small amounts of color-adjusting dyes can be used in combination with a suitably pigmented layer in a manner analogous to that described in connection with FIG. 2 to achieve the desired succedaneum for the conventional product.

The optical bodies of the invention can be used in any application to provide a stable neutral color tint or a neutral density filter. The optical bodies can incorporate or be applied to other optical bodies or films to combine multiple optical effects. For example, the optical bodies can be incorporated along with one or more additional optically active layers to form an IR mirror, UV absorption construction, solar control construction, polarizer, or decorative construction. Similarly, the pigmented optical bodies of the invention can be used to tint automotive or window glazings, such as glass or polycarbonates. The pigmented optical bodies also find application in the construction of puncture or tear-resistant films, safety and security films, and as contrast enhancement layers for optical displays, for example, computer monitors, television screens, and the like.

The following examples are offered to aid in the understanding of the present invention and are not to be construed as limiting the scope thereof. Unless otherwise indicated, all parts and percentages are by weight.

### EXAMPLES

Particle Dispersion A1

In a 1500 liter vessel, 81.5% by weight of ethylene glycol and 7.6% by weight CoPVP (polyvinylpyrrolidone) wetting agent were intensively mixed for about 60 minutes using a high speed, high shear Cowles “Dissolver” mixer. While continuing to mix, 10.9%, by weight gas black (a type of carbon black, specifically Cabot Black Pearls 1300 which is said to have 13 nm particle size) was slowly added to the ethylene glycol mixture. After one hour at high speed, the mixture was pumped through a (200 liter, Netzsch vertical) sand mill containing a 50%, by volume, loading of uniform 1.0-1.25 mm ceramic beads. The mixture was passed through the mill 20 times yielding a uniform dispersion of carbon black particles. The dispersion was passed first through a 15-micron and then a 5 micron cartridge filter. Analysis with a Hegman Gauge and light microscopy indicated that the dispersion was free of agglomerations larger than 1 micron, Microtrac™ particle analyzer indicated that the volume fraction average particle/agglomerate size in the dispersion was less than 300 nm.

Particle Dispersion A2

In a 210 liter vessel, 94.59% by weight of ethylene glycol and 0.43% by weight CoPVP (polyvinylpyrrolidone) wetting agent were intensively mixed for about 60 minutes using a high speed, high shear Cowles “Dissolver” mixer equipped with a 25 cm diameter mixing blade. While continuing to mix, 4.98% by weight gas black (specifically Degussa FW200 which is said to have 13 nm particle size) was slowly added to the ethylene glycol mixture. After one hour at 1700 rpm, the mixture was pumped at 1 liter per minute through a high shear (13 liter, Netzsch horizontal) sand mill containing a 50%, by volume, loading of uniform 4.75 mm stainless steel beads and shaft rpm of 900. The mixture was passed through the mill 5 times, even though a uniform dispersion of carbon black particles was observed after only 3 passes through the mill. The dispersion was passed through a 3-micron cartridge filter. The finished dispersion was held in a vessel equipped with low speed agitation from a Cowles Dissolver until ready for addition to the reactor. Analysis with a Hegman Gauge and light microscopy indicated that the dispersion was free of agglomerations larger than 1 micron. A Microtrac™ brand particle analyzer indicated that the volume fraction average particle/agglomerate size in the dispersion was less than 200 mn.

Masterbatch A1

Into a 15,000 liter reactor equipped with a turbine agitator and a hot oil jacket were charged 100 parts by weight of dimethyl terephthalate, 62.32 parts of ethylene glycol, 0.02 parts cobalt acetate, 0.02 parts zinc acetate, 0.03 parts antimony acetate, and 28 parts of Particle Dispersion A1. While agitating at a pressure of 138 kPa, the batch temperature was gradually raised to 249° C., while fractionating off 33 parts by weight of methanol. When the batch reached 255° C., over a period of ten minutes, the kettle pressure decreased to 101.3 kPa. The reactor was isolated and 0.039 parts triethyl phosphonoacetate was added and allowed to mix for five minutes. The reactor contents were transferred to two 5,000-liter polymerization vessels equipped with anchor agitators and a hot oil jacket, and the solution temperature was adjusted to 198° C. The solution temperature was increased to 260° C. at 0.6° C. per minute to remove excess ethylene glycol. At 260° C. the vessel pressure was reduced to 0.133 kPa or less over a 20-minute period while the solution temperature was raised to 285° C. The mixture polymerized under these conditions to an intrinsic viscosity of 0.59 in trifluoroacetic acid. It was drained from the reactors using nitrogen pressure through a strand die, quenched with room temperature water in a water bath, and cut into chips.

Masterbatch A2

Into a 380 liter reactor equipped with a turbine agitator and a hot oil jacket were charged 100 parts by weight of dimethyl terephthalate, 62.32 parts of ethylene glycol, 0.02 parts cobalt acetate, 0.02 parts zinc acetate, 0.03 parts antimony acetate, and 40.8 parts of Particle Dispersion A2. While agitating at a pressure of 138 kPa, the batch temperature was gradually raised to 249° C., while fractionating off 33 parts by weight of methanol. When the batch reached 255° C., over a period of ten minutes, the kettle pressure decreased to 101.3 kPa. The reactor was isolated and 0.039 parts triethyl phosphonoacetate was added and allowed to mix for five minutes. The reactor contents were transferred to a 380-liter polymerization vessel equipped with an anchor agitator and a hot oil jacket, and the solution temperature was adjusted to 198° C. The solution temperature was increased to 260° C. at 0.6° C. per minute to remove excess ethylene glycol. At 260° C. the vessel pressure was reduced to 0.133 kPa or less over a 20-minute period while the solution temperature was raised to 285° C. The mixture polymerized under these conditions to an intrinsic viscosity of 0.59 in trifluoroacetic acid. It was drained from the reactor using nitrogen pressure through a strand die, quenched with room temperature water in a water bath, and cut into chips.

Masterbatch B1

2.5% Violet Dye in PET provided by Clariant Masterbatches Division. Color number NE42642422

Masterbatch B2

0.25% Violet Dye in PET provided by Clariant Masterbatches Division. Product Code 00044426.

Masterbatch C

2.25% Ceres Blue Dye in PET provided by Clariant Masterbatches Division. Product Code 00041030.

Film Process A

Into a twin screw extruder was fed a blend ranging from 67.2 parts polyethylene terephthalate, 22.1 parts Masterbatch A1, 7 parts Masterbatch B1, and 3.7 parts Masterbatch C to 78.8 parts polyethylene terephthalate, 14.6 parts Masterbatch A1, 3.8 parts Masterbatch B1, and 2.8 parts Masterbatch C (see table of examples). While heated to 287° C., the contents were passed through 10 micrometer metal filters, and fed through a drop die to provide a single polyester sheet. The sheet was about 0.32 mm in thickness and about 43 cm wide. After being quenched on a water-cooled casting roll, the sheet was biaxially oriented about 3.5 times in each direction and heat set at 238° C. to provide a film base about 0.023 mm in thickness.

Film Process B

Into a first twin screw extruder was fed a blend ranging from 35.4 parts of polyethylene terephthalate, 13.5 parts Masterbatch A2, and 6.1 parts of Masterbatch C to 41.9 parts of polyethylene terephthalate, 9.8 parts Masterbatch A2, and 3.5 parts of Masterbatch C. Into a second twin screw extruder were fed 45 parts of polyethylene terephthalate (see table of examples). While heated to 276° C., the contents of both extruders were passed through 7 micrometer metal filters. The two streams were simultaneously fed through a drop die to provide a single two-layer polyester sheet, the first layer of which contained Masterbatch A2, Masterbatch C, and polyethylene terephthalate and the second layer of which contained polyethylene terephthalate. Each layer was about 0.16 mm in thickness, and the width of the two-layer sheet was about 44 cm. After being quenched on a water-cooled casting roll, the sheet was biaxially oriented about 3.5 times in each direction and heat set at 238° C. to provide a film base about 0.023 mm in thickness.

Film Process C

Into a twin screw extruder was fed a blend ranging from 18.8 parts polyethylene terephthalate, 15.1 parts Masterbatch A2, and 66.1 parts Masterbatch B2 to 65.4 parts polyethylene terephthalate, 6.6 parts Masterbatch A2, and 28.0 parts Masterbatch B2 (see table of examples). While heated to 291° C., the contents were passed through 10 micrometer metal filters, and fed through a drop die to provide a single polyester sheet. The sheet was about 0.32 mm in thickness and about 44 cm wide. After being quenched on a water-cooled casting roll, the sheet was biaxially oriented about 3.5 times in each direction and heat set at 238° C. to provide a film base about 0.023 mm in thickness.

Testing Methods

A Microtrac™ model 7995-00 Particle Size Analyzer was used to analyze carbon black particles larger than 120 nm in the ethylene glycol dispersion. This Analyzer generates a volume average distribution of particle size.

Hegman-Type Gage determined the degree of dispersion (commonly referred to as “fineness of grind”) of the carbon black in ethylene glycol. It also was used to assess the inclusion of particulates by a cleanliness (or texture) rating.

Light microscopy was also used to observe the quality of the carbon black ethylene glycol dispersion. The degree of particle flocculation was observed under no shear conditions.

A Gardner PG-5500 Digital Photometric Unit and a Gardner XL211 Hazegard™ System were used according to ASTM D1003 to measure total haze. Total haze is the “percent of total transmitted light which, in passing through the specimen deviated from the incident beam through forward scatter by more than 0.044 rad (2.5°) on average. The Gardner PG-5500 was also used, in conjunction with an index matching fluid, to measure internal haze. The difference between total haze and internal haze is the surface haze.

Caliper was measured with the Measuretech series 2000 capacitance thickness gauge.

Percent transmission was measured by a spectrophotometer and averaged over the visible spectrum, 400-700nm. The light level with the sample “in” the spectrophotometer was compared to the light level with the sample “out” at each wavelength, thus yielding a percent transmission that included the component due to surface reflections.

Surface roughness, Rₐ, can be measured according to ASTM F 1811-97 by a Veeco Wyko NT3300 equipped with the RST Plus surface profiling system. The RST Plus is a non-contact optical profiler that uses two technologies to measure a wide range of surface heights. Phase-shifting interferometry (PSI) measures smooth surfaces while vertical-scanning interferometry (VSI) mode measures rough surfaces. Rₐ values can be expressed in units of nanometers.

Particulate pigment loading is calculated for only the pigmented layer, and not necessarily for the total construction. Particulate pigment loading can be calculated by the following equation:

$${X}_{P} = \frac{( {X}_{P , M B} * {W}_{M B} )}{( {W}_{M B} + {W}_{A} )}$$

where:

X_{P} is the weight fraction of particulate in the pigmented layer;

X_{P,MB} is the weight fraction of particulate pigment in the Masterbatch;

W_{MB} is the flow rate, in kg/hr, of Masterbatch in the pigmented layer; and

W_{A} is the flow rate, in kg/hr, of base material in the pigmented layer.

Accelerated UV weathering studies were performed on films of the examples using techniques similar to those described in ASTM G-151, “Standard Practice for Exposing Nonmetallic Materials in Accelerated Test Devices That Use Laboratory Light Souces” in conjunction with ASTM G-155, “Standard Practice for operating Xenon Arc Light Apparatus for Exposure of Non-Metallic Materials”. The particular technique used involves exposing the sample film to a xenon arc lamp and monitoring the color-scale a*, b* parameters as a function of exposure time. Prior experience with the particular setup has indicated an acceleration factor of roughly ten to fifteen—i.e., exposure to the xenon arc lamp for a time t is comparable to actual outdoor exposure time of 10 t to 15 t. Other accepted accelerated weathering techniques can also be used, as can non-accelerated weathering tests by exposing the test films to actual sunlight.

### Examples 1-2

Examples in Table 1 were produced by Film Process A.

TABLE 1

| | Masterbatch/ | Masterbatch/ | Masterbatch/ | Trans- | Haze | | |
|---|---|---|---|---|---|---|---|
| Example | feed fraction | feed fraction | feed fraction | mission (%) | (%) | a* | b* |
| 1 | A1/0.221 | B1/0.070 | C/0.037 | 20.7 | 3.5 | −1.0 | −2.4 |
| 2 | A1/0.147 | B1/0.038 | C/0.028 | 38.2 | 2.7 | −1.1 | −0.4 |

### Examples 3-4

Examples in Table 2 were produced by Film Process B. Feed fraction shown in the table is based on total extrusion throughput.

TABLE 2

| Ex- | Masterbatch/ | Masterbatch/ | Transmission | Haze | | |
|---|---|---|---|---|---|---|
| ample | feed fraction | feed fraction | (%) | (%) | a* | b* |
| 3 | A2/0.098 | C/0.035 | 47.8 | 2.2 | −1.8 | 2.1 |
| 4 | A2/0.135 | C/0.061 | 36.6 | 2.8 | −3.0 | 0.7 |

### Examples 5-7

Examples in Table 3 were produced by Film Process C.

TABLE 3

| Ex- | Masterbatch/ | Masterbatch/ | Transmission | Haze | | |
|---|---|---|---|---|---|---|
| ample | feed fraction | feed fraction | (%) | (%) | a* | b* |
| 5 | A2/0.066 | B2/0.280 | 55.0 | 1.0 | 0.5 | 1.0 |
| 6 | A2/0.108 | B2/0.469 | 38.4 | 1.4 | 0.7 | 1.2 |
| 7 | A2/0.151 | B2/0.661 | 25.4 | 2.1 | 1.2 | 1.7 |

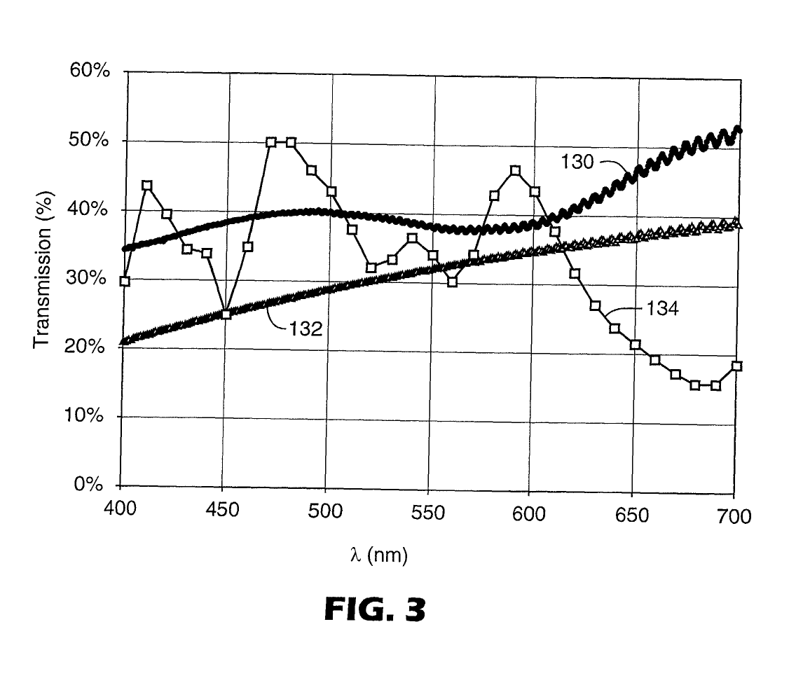

The spectral percent transmission (percent transmission as a function of wavelength λ) of Example 6 was measured and is shown in FIG. 3. In that figure, trace 130 is the spectral percent transmission of Example 6, trace 132 is the measured spectral percent transmission of a PET film with carbon black pigment and no color adjusting dye (Example 11 of copending U.S. application Ser. No. 09/633,911, having 31% transmission over the visible spectrum), and trace 134 is the measured spectral percent transmission of a conventional dyed PET glazing film having a 35% nominal transmission over the visible spectrum. As shown, the color-adjusting dyes modify to a small but significant degree the shape of trace 132 to yield trace 130.

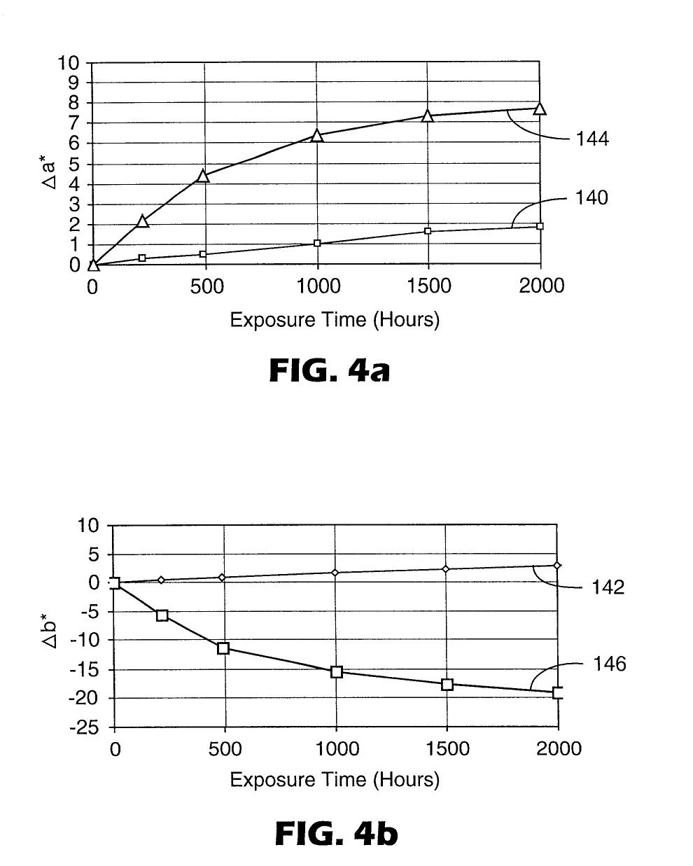

The color stability of the film of Example 2 was checked with an accelerated weathering device. FIGS. 4a and 4b show respectively the change (from the initial value) in a* and the change in b* of the sample as a function of exposure time in front of the xenon arc lamp. The respective curves for the Example 2 film are labeled 140, 142. Also shown are the results of a conventional dyed PET glazing film that had initial a*, b* coordinates of −2.9, +0.4 and a nominal percent transmission of 35%. The curves for the conventional glazing film are labeled 144, 146. As shown, the combination pigmented/dyed film of Example 2 is substantially more color stable than the conventional glazing film.

Various modifications and alterations of this invention will be apparent to those skilled in the art without departing from the scope and spirit of this invention, and it should be understood that this invention is not limited to the illustrative embodiments set forth herein.

We claim:

1. A pigmented optical body comprising at least one layer of a thermoplastic polymer material, wherein dispersed within the polymer material is between 0.01 and 1 percent by weight of a particulate pigment having a mean diameter no more than 500 nm, wherein the optical body exhibits a transmission of light within a wavelength band of interest within the visible spectrum of from 5% to 90%, wherein the dispersed particulate pigment imparts a substantial transmitted color to the optical body, the optical body further comprising at least one dye added in an amount sufficient to adjust the transmitted color of the optical body to a substantially neutral gray.

2. The body of claim 1, wherein the optical body has an a* value and a b* value in the range of ±5.

3. The body of claim 2, wherein the optical body has an a* value and a b* value in the range of ±13.

4. The body of claim 3, wherein the optical body has an a* value and a b* value in the range of ±1.

5. The body of claim 1, wherein the optical body has an a* value and a b* value in the range of −1.5 ±5.

6. The body of claim 5, wherein the optical body has an a* value and a b* value in the range of −1.5 ±3.

7. The body of claim 6, wherein the optical body has an a* value and a b* value in the range of −1.5 ±1.

8. The body of claim 1, wherein the particulate pigment has a mean diameter of no more than 300 mn.

9. The body of claim 8, wherein the particulate pigment has a mean diameter of no more than 100 nm.

10. The body of claim 1, wherein the body exhibits an internal haze of no more than 5%.

11. The body of claim 1, wherein the at least one dye is disposed in the at least one layer of thermoplastic polymer material.

12. The body of claim 1, wherein the at least one dye is co-polymerized in the polymer material.

13. The body of claim 1, wherein the at least one dye adjusts the transmitted color of the optical body by no more than 15 units of a* and by no more than 15 units of b*.

14. A pigmented optical body comprising at least one layer of a thermoplastic polymer material having dispersed therein a particulate pigment in an amount effective to produce a tint perceptible to an observer, wherein the optical body exhibits a transmission of light within a wavelength band of interest within the visible spectrum of from 5 to 90% and exhibits an internal haze of less than or equal to 5%, the optical body further comprising at least one dye in an amount effective to adjust the color of the optical body by no more than 15 units of a* and by no more than 15 units of b*.

15. The body of claim 14, wherein the body has a substantially neutral gray color.

16. The body of claim 15, wherein the body has an a* value and a b* value in the range of −1.5 ±1.

17. The body of claim 14, wherein the at least one layer is a single layer and the optical body consists essentially of the single layer.

18. The body of claim 14, wherein the particulate pigment has a mean diameter of no more than 500 nm.

19. The body of claim 14, wherein the at least one dye is disposed in the at least one layer of thermoplastic polymer material.

20. The body of claim 14, wherein the at least one dye is co-polymerized in the polymer material.

21. The body of either claim 1 or claim 14, wherein the body further comprises a rigid window member to which the at least one layer is laminated.
